(19) United States
(12) Patent Application Publication
(10) Pub. No.: US 2019/0308246 A1
(43) Pub. Date: Oct. 10, 2019

(54) Apparatus and Process for Forming Powder

(71) Applicant: Aurora Labs Limited, Bibra Lake, Western Australia (AU)

(72) Inventors: David Budge, Bibra Lake, Western Australia (AU); John Nathan Henry, Bibra Lake, Western Australia (AU)

(73) Assignee: Aurora Labs Limited, Bibra Lake, Western Australia (AU)

(21) Appl. No.: 16/335,924

(22) PCT Filed: Sep. 21, 2017
(86) PCT No.: PCT/AU2017/000202

§ 371 Date: Mar. 22, 2019

(30) Foreign Application Priority Data
Sep. 23, 2016 (AU) 2016903874
Jun. 6, 2017 (AU) 2017902152

(51) Int. Cl. B22F 9/10; B01J 19/12; B01J 19/08

(52) U.S. Cl. CPC B22F 9/10; B01J 19/121; B22F 2009/0888; B22F 2999/00; B01J 19/088

(57) ABSTRACT

An apparatus is for forming powder, and includes an energy source for emitting at least one energy beam onto a workpiece, the energy beam being configured to melt the workpiece, at least in part, to form at least one pool of molten material on the workpiece. The apparatus is configured to exert a force on the workpiece causing at least a bead of molten material to be ejected from the pool and solidify to form a particle of powder.

### FIELD OF INVENTION

The present invention relates to an apparatus and process for forming powder and, more particularly but not exclusively, for forming metal powders.

### BACKGROUND

Powders are used in a wide variety of industrial fabrication processes. Metal powders, in particular, are used in additive fabrication processes such as 3D printing.

Known processes for forming metal powders include crushing, milling, and atomization of source metals. These processes are time consuming to perform and result in the generation of powder particles that are of a poor quality and have highly irregular sizes and dimensions. This lack of uniformity significantly reduces the utility of these powders for 3D printing.

It is an object of the present invention to provide a powder production apparatus and process that, at least in part, ameliorates and overcomes these problems.

### SUMMARY OF THE INVENTION

In accordance with one aspect of the present invention, there is provided an apparatus for forming powder, comprising:
an energy source for emitting at least one energy beam onto a workpiece, the energy beam being configured to melt the workpiece, at least in part, to form at least one pool of molten material on the workpiece, and
a scanning means configured to determine a position, velocity and/or surface profile of the workpiece,
   wherein the apparatus is configured to exert a force on the workpiece causing at least a bead of molten material to be ejected from the pool and solidify to form a particle of powder.

Preferably the apparatus further comprises combinatorial logic circuitry configured to operate in conjunction with the scanning means to control parameters of the apparatus that affect the size and frequency of formed particles of powder.

Preferably the parameters controlled by the combinatorial logic circuitry comprise intensity of the energy beam and surface area of the workpiece onto which the energy beam is focussed.

Preferably the scanning means are further configured to determine size and shape of each airborne particle of powder while it travels from the workpiece to a stockpile, and wherein the combinatorial logic circuitry is further configured to direct the energy beam onto an airborne particle to control its rate of cooling.

The apparatus may further comprise a motor configured to rotate the workpiece about an axis thereby exerting a centrifugal force on the workpiece causing the bead to be ejected away from the axis.

The workpiece may comprise a plurality of elongate channels are formed in the workpiece, each channel extending away from the centre axis and terminating at a peripheral edge of the workpiece, wherein each channel is configured to carry molten material flowing across the surface of the workpiece towards the edge, and wherein each channel has a cross sectional shape and size that determines a shape and size of beads of molten material that are ejected away from the edge.

The energy source may be configured to melt the workpiece such that the plurality of channels are formed by the energy source.

The apparatus may further comprise a vibration means configured to oscillate the workpiece causing the bead to be ejected from the pool.

The apparatus may further comprise a charging means configured to exert a magnetic or an electrostatic force on the workpiece causing the bead to be ejected from the pool.

The energy source may be configured to focus the energy beam onto a section of the workpiece having a surface area of less than 1,000,000 square microns (μm²) (1 mm²).

The energy source may be configured to focus the energy beam onto a section of the workpiece having a surface area of less than 10 square microns (μm²).

The energy source may be selected from any one of a laser beam, collimated light beam, micro-plasma welding arc, electron beam or particle accelerator.

The apparatus may further comprise an energy splitting means for splitting the energy beam into a plurality of separate energy beams directed onto the workpiece.

The apparatus may comprise a plurality of energy sources for emitting a plurality of separate energy beams onto the workpiece.

The apparatus may further comprise a focussing means for focussing the plurality of separate energy beams onto a common focal point on the workpiece.

The workpiece may consist substantially of a metallic material for forming a metal powder.

The workpiece may be cylindrical.

The workpiece may be conical.

The workpiece may consist substantially of titanium.

The workpiece may consist substantially of stainless steel or steel alloy.

The workpiece may consist substantially of a pure metal, metal alloy, metal-based cermet or other metallic material.

The workpiece may consist of a non-metallic material for forming a non-metallic powder.

The workpiece may consist substantially of a ceramic, metal oxide, cermet, composite or other suitable material for forming powder.

The apparatus may further comprise a scanning means configured to determine a position, velocity and/or surface profile of the workpiece.

The scanning means may be further configured to measure the size and shape of each particle of powder.

The apparatus may further comprise a valve unit for ejecting accumulated powder particles from the apparatus.

In accordance with one further aspect of the present invention, there is provided a process for forming powder, the process comprising the steps of:
emitting at least one energy beam from an energy source onto a workpiece to melt the workpiece, at least in part, forming at least one pool of molten material on the workpiece;
exerting a force on the workpiece to cause at least a bead of molten material to be ejected away from the pool and solidify to form at least a particle of powder.

The process may further comprise:
focussing the energy source on the workpiece such that a plurality of channels are formed in the workpiece, each channel extending away from the centre axis and terminating at a peripheral edge of the workpiece; and
allowing molten material to flow across the surface of the workpiece and through the channels towards the peripheral edge such that beads of molten material are ejected away from the edge.

### BRIEF DESCRIPTION OF DRAWINGS

The present invention will now be described, by way of example, with reference to the accompanying drawings, in which:

FIG. 1 shows an apparatus for forming powder according to an embodiment of the present invention;

FIG. 2 shows an apparatus for forming powder according to a further embodiment of the present invention; and

FIG. 3 shows an apparatus for forming powder according to a further embodiment of the present invention.

FIG. 4 shows an apparatus for forming powder according to a further embodiment of the present invention.

### DETAILED DESCRIPTION OF THE DRAWINGS

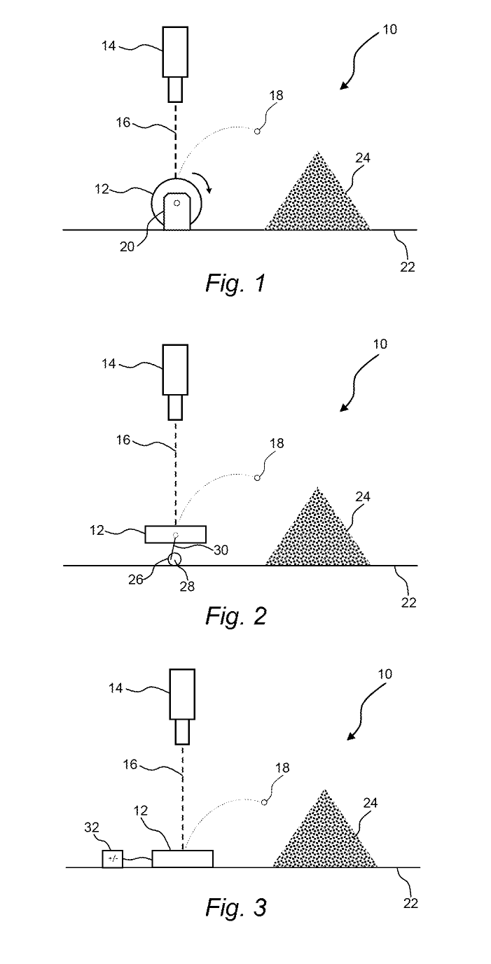

Referring to FIG. 1, there is shown an apparatus for forming powder according to a first embodiment of the present invention, being referred to generally by reference numeral 10.

The apparatus 10 comprises a workpiece 12 and an energy source 14 for emitting at least one energy beam 16 onto the workpiece 12, the energy beam 16 being configured to melt the workpiece 12, at least in part, to form at least one pool of molten material on the workpiece 12. The apparatus 10 is configured to exert a force on the workpiece 12 causing a bead of molten material to be ejected from the pool and solidify to form a particle of powder 18.

More particularly, the workpiece 12 is cylindrical in shape.

Alternatively, the workpiece 12 is conical in shape.

The workpiece 12 is, preferably, substantially comprised of a metallic material for forming particles of metal powder. For example, the workpiece 12 is, preferably, substantially comprised of either titanium, stainless steel or steel alloy, or metal-based cermet.

In alternative embodiments, the workpiece 12 may be substantially comprised of a non-metallic material such as, for example, a ceramic, metal oxide, cermet, composite or other suitable non-metallic material for forming non-metallic powder.

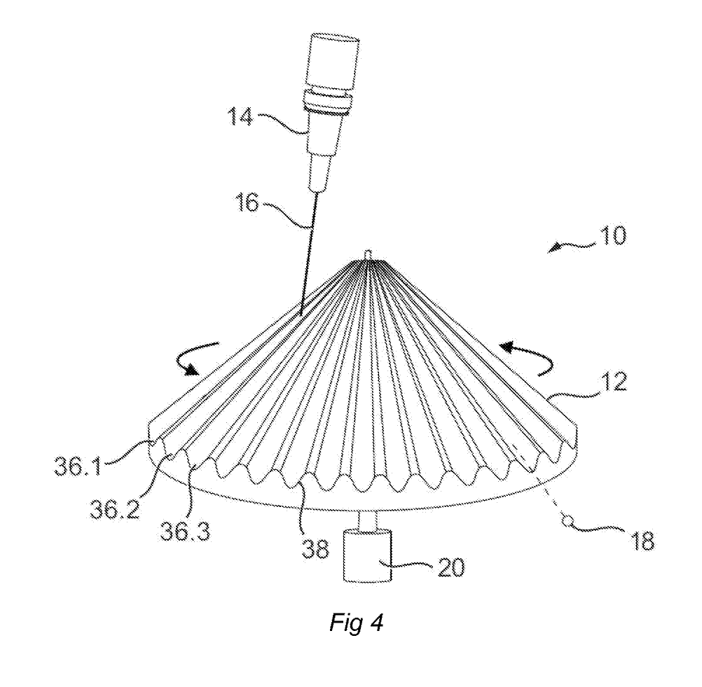

As shown in FIG. 4, the energy source 14 may be configured to melt the workpiece 12 such that a plurality of elongate channels 36 are formed in the workpiece 12, each channel 36 extending away from the centre axis and terminating at a peripheral edge 38 of the workpiece 12.

Each channel 36 is configured to carry molten material flowing across the surface of the workpiece 12 towards the peripheral edge 38 and each channel 36 has a cross sectional shape and size that determines a shape and size of beads of molten material 18 that are ejected away from the edge 38.

The apparatus 10 may further comprise a motor 20 that is configured to rotate the workpiece 12 at high speed about its longitudinal axis. The motor 20 depicted in FIG. 1 is configured to rotate the workpiece 12 about its axis in a clockwise direction.

The energy source 14 is, preferably, either a laser beam, collimated light beam, micro-plasma welding arc, electron beam or particle accelerator.

The energy source 14 is configured to focus the energy beam 16 onto a section of the workpiece 12 that has a surface area of less than 1,000,000 square microns (μm²) and, preferably, less than 10,000 square microns (μm²).

In use, the energy beam 16 directed onto the section of the workpiece 12 for a sufficient period of time that causes the temperature of the section to rise and melt to form a small pool of molten material. The rotational movement of the workpiece 12 causes a centrifugal force to be exerted on the workpiece 12 and pool. This causes a bead of molten material to form and be ejected from the pool radially away from the rotary axis of the workpiece 12. Due to the high rotational speed of the workpiece 12, the bead is caused to be ejected almost immediately following the formation of the pool of molten material.

The bead that is ejected solidifies as it travels through the air or vacuum surrounding the workpiece 12 and forms a single powder particle 18. Due to the surface tension of the molten bead, the powder particle 18 that is formed has a near perfect spherical shape. The moving spherical powder particle 18 travels through the surrounding space until it comes to rest onto an operative surface 22 of the apparatus 10. This process is repeated in order to generate further powder particles 18. The particles 18 accumulate onto a stock pile 24 formed on the operative surface 22.

The apparatus 10 further comprises a valve unit (not shown) which periodically opens thereby causing powder collected in the stock pile 24 to be expelled from the apparatus 10 so that it can be packed and stored for subsequent use. The powder generation process is stopped when all source material on the workpiece 12 has been depleted.

The apparatus 10 further comprises a scanning means (not shown) that is configured to determine, in real time, the position, rotational velocity and/or surface profile of the workpiece 12 during use and the size and shape of each particle of powder 18 formed using the apparatus 10. These data are used, in conjunction with combinatorial logic circuitry, to control the parameters and components of the apparatus 10 that affect the size and frequency of formed powder particles 18. This includes, in particular, the speed at which the workpiece 12 is rotated, the duration of time for which the energy beam 16 is directed onto the workpiece 12, the intensity of the energy beam 16 and the surface area of the workpiece 12 section that the energy beam 16 is focussed onto for each particle 18.

The scanning means are also configured to determine the size and shape of each airborne particle of powder 18 while it travels from the workpiece 12 to the stock pile 24 and solidifies. These data are further used to control the direction and intensity of the energy beam 16 including, if necessary, directing the energy beam 16 onto the airborne particle 18 to control its rate of cooling.

The scanning means and combinatorial logic circuitry are also configured to control the order, and respective locations, of the workpiece 12 sections that the energy beam 16 selectively works on. This provides that the workpiece 12 is worked on in a consistent and uniform manner so that the shape of the workpiece 12 stays substantially even and balanced during use.

The embodiment shown in FIG. 1 comprises a single energy source 14 that is configured to emit a single energy beam 16. The apparatus 10 may, however, alternatively comprise a plurality of energy sources that are configured to emit a plurality of energy beams onto multiple sections of the workpiece 12, simultaneously or successively, in order to increase the speed of the powder forming process.

The apparatus 10 may, alternatively, comprise a single energy source 14 that operates in conjunction with an energy splitting means for splitting the single energy beam 16 that is emitted by the energy source 14 into a plurality of separate energy beams are directed them onto the workpiece 12.

In embodiments of the invention that are configured to direct a plurality of individual energy beams onto the workpiece 12, the apparatus 10 further comprises a focussing means which is adapted to, in use, focus one or more of the individual energy beams onto a common focal point on the workpiece 12.

Referring to FIG. 2, there is shown an apparatus for forming powder 10 according to a further embodiment of the invention. The apparatus 10 is identical in all material respects to the embodiment shown in FIG. 1 except that the apparatus 10 does not comprise a motor 20. Instead, the apparatus 10 comprises a vibration means 26 which is configured to move the workpiece 12 back and forth in an oscillating motion. The vibration means 26 is depicted in the form of a simple drive wheel 28 and piston 30 configured to move the workpiece 12 up and down in a sinusoidal manner relative to the operative surface 22.

In use, an energy beam 16 is emitted from the energy source 14 and directed onto a section of the workpiece 12 for a period of time causing the section to melt and form a small pool of molten material. The oscillating motion of the workpiece 12 causes a bead of molten material to be ejected from the pool away from the workpiece 12. This process is repeated for subsequent particles of powder.

Referring to FIG. 3, there is shown an apparatus for forming powder 10 according to a further embodiment of the invention. The apparatus 10 is identical in all material respects to the embodiment shown in FIG. 2 except that the apparatus 10 does not comprise a vibration means 26. Instead, the apparatus 10 comprises a charging means 32 which is configured to apply a magnetic or an electrostatic force to the workpiece 12.

In use, an energy beam 16 is emitted from the energy source 14 and directed onto a section of the workpiece 12 for a period of time causing the section to melt and form a small pool of molten material. The magnetic or electrostatic force causes a bead of molten material to be ejected from the pool away from the workpiece 12. This process is repeated for subsequent particles of powder.

Referring to FIG. 4, there is shown an apparatus for forming powder 10 according to a further embodiment of the invention. In this embodiment of the apparatus 10, the energy beam 16 is also directed such that the workpiece 12 is melted to form the plurality of channels 36, each channel 36 extending away from the centre axis and terminating at a peripheral edge 38 of the workpiece 12.

The rotating motion of the workpiece 12 causes a centrifugal force to be exerted on the workpiece 12 and molten material formed on the surface. This causes the molten material to flow away from the centre axis towards the peripheral edge 38 of the workpiece 12. As the molten material flows towards the edge 38, the material is caused to flow into, and travel along, each of the elongate channels 36. When molten material has reached the end of a channel 36, the centrifugal force causes beads of molten material to be ejected radially away from the channel exit and workpiece 12.

A single powder particle 18 of molten material is shown in FIG. 4 travelling radially away from the workpiece 12 towards the bottom right hand side of the Figure. However, it will be appreciated that when the apparatus 10 is in use, a large number of beads will form powder particles 18 at the peripheral edge 38, the powder particles 18 being ejected away from the workpiece 12 at any one point it time.

The energy beam 16 is directed onto the workpiece 12 selectively such that each channel 36 that is formed has a specific cross-sectional shape and size at the peripheral edge 38 of the workpiece 12. The cross-sectional shape and size determines the shape and size of the beads of molten material ejected from the workpiece 12 and the shape and size of the powder particles 18 that are subsequently formed. This advantageously enables the shape, size and morphology of the powder particles 18 manufactured to be accurately controlled. Powder particles 18 having a highly regular shape, size and morphology can, therefore, be manufactured.

The channels 36 are, preferably, formed simultaneously while the molten material is being formed generally on the surface of the workpiece 12. The shape, size and morphology of the channels 36 is continually monitored and controlled by the apparatus 10 while powder particles 18 are being formed. This provides that the workpiece 12 can be used continually until the material comprised in the workpiece 12 has been depleted.

The apparatus 10 herein disclosed advantageously enables particles of powder to be formed that each having a near spherical shape. The size and shape of the particles are highly uniform and are, therefore, well suited in particular for use in additive industrial fabrication processes such as 3D printing.

The apparatus 10 further advantageously enables particles of powder 18 to be formed at high speed.

In accordance with one further aspect of the present invention, there is provided a process for forming powder particles 18, the process comprising the steps of:
emitting at least one energy beam 16 from an energy source 14 onto a workpiece 12 to melt the workpiece 12, at least in part, forming at least one pool of molten material on the workpiece 12;
exerting a force on the workpiece 12 to cause a bead of molten material to be ejected away from the pool and solidify to form a particle of powder 18; and repeating the steps above to form further particles of powder 18.

The process may further comprise focussing the energy source 14 on the workpiece 12 such that a plurality of channels 36 are formed in the workpiece 12, each channel 36 extending away from the centre axis and terminating at a peripheral edge 38 of the workpiece 12, and allowing molten material to flow across the surface of the workpiece 12 and through the channels 36 towards the edge 38 such that beads of molten material are ejected away from the edge 38 to form the particles of powder 18.

Further modifications and variations as would be apparent to a skilled addressee are deemed to be within the scope of the present invention.

In the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

1-23. (canceled)

24. An apparatus for forming powder, comprising:
an energy source for emitting at least one energy beam onto a workpiece, the energy beam being configured to melt the workpiece, at least in part, to form at least one pool of molten material on the workpiece, and
a sensor means configured to determine a position, velocity and/or surface profile of the workpiece,
wherein the apparatus is configured to exert a force on the workpiece causing at least a bead of molten material to be ejected from the pool and solidify to form a particle of powder,
wherein the sensor means is further configured to determine the size and shape of each particle of powder formed by the apparatus,
wherein the apparatus further comprises combinatorial logic circuitry configured to operate in conjunction with the sensor means to control parameters of the apparatus that affect the size and frequency of formed particles of powder, and
wherein the parameters controlled by the combinatorial logic circuitry comprise intensity of the energy beam, force exerted on the workpiece and surface area of the workpiece onto which the energy beam is focused.

25. The apparatus according to claim 24, wherein the sensor means are further configured to determine size and shape of each airborne particle of powder while it travels from the workpiece to a stockpile, and wherein the combinatorial logic circuitry is further configured to direct the energy beam onto an airborne particle to control its rate of cooling.

26. The apparatus according to claim 24, wherein the workpiece comprises a plurality of elongate channels, each channel extending away from a center axis and terminating at a peripheral edge of the workpiece, wherein each channel is configured to carry molten material flowing across the surface of the workpiece towards the edge, and wherein each channel has a cross sectional shape and size that determines a shape and size of beads of molten material that are ejected away from the edge.

27. The apparatus according to claim 24, wherein the energy source is configured to melt the workpiece such that the plurality of channels are formed by the energy source.

28. The apparatus according to claim 24, the apparatus comprising a motor configured to rotate the workpiece about an axis thereby exerting a centrifugal force on the workpiece causing the bead to be ejected away from the axis.

29. The apparatus according to claim 24, wherein the apparatus comprises a vibration means configured to oscillate the workpiece causing the bead to be ejected from the pool.

30. The apparatus according to claim 24, wherein the apparatus comprises a charging means configured to exert a magnetic or an electrostatic force on the workpiece causing the bead to be ejected from the pool.

31. The apparatus according to claim 24, wherein the energy source is configured to focus the energy beam onto a section of the workpiece having a surface area of less than 1,000,000 square microns (μm²) (1 mm²).

32. The apparatus according to claim 24, wherein the energy source is configured to focus the energy beam onto a section of the workpiece having a surface area of less than 10 square microns (μm²).

33. The apparatus according to claim 24, wherein the energy source is selected from the group consisting of laser beam, collimated light beam, micro-plasma welding arc, electron beam and particle accelerator.

34. The apparatus according to claim 24, wherein the apparatus comprises an energy splitting means for splitting the energy beam into a plurality of separate energy beams directed onto the workpiece.

35. The apparatus according to claim 24, wherein the apparatus comprises a plurality of energy sources for emitting a plurality of separate energy beams onto the workpiece.

36. The apparatus according to claim 24, wherein the apparatus comprises a focussing means for focussing a plurality of separate energy beams onto a common focal point on the workpiece.

37. The apparatus according to claim 24, wherein the workpiece is substantially cylindrical.

38. The apparatus according to claim 24, wherein a surface of the workpiece is substantially conical.

39. The apparatus according to claim 24, wherein the workpiece consists substantially of a metallic material for forming a metal powder.

40. The apparatus according to claim 24, wherein the workpiece consists substantially of material selected from the group consisting of titanium, stainless steel, steel alloy, metal-based cermet.

41. The apparatus according to claim 24, wherein the workpiece consists substantially of a non-metallic material for forming a non-metallic powder.

42. The apparatus according to claim 24, wherein the workpiece consists substantially of a ceramic, metal oxide, cermet, composite or other suitable material for forming powder.

43. The apparatus according to claim 24, wherein the apparatus comprises a valve unit for ejecting accumulated powder particles from the apparatus.

44. A method for forming powder, the method comprising the steps of:
emitting at least one energy beam from an energy source onto a workpiece to melt the workpiece, at least in part, forming at least one pool of molten material on the workpiece;
using a sensor means to determine a position, velocity and/or surface profile of the workpiece;
using combinatorial logic circuitry configured to operate in conjunction with the sensor means to control parameters of the apparatus that affect the size and frequency of formed particles of powder;
wherein the parameters controlled by the combinatorial logic circuitry comprise intensity of the energy beam, force exerted on the workpiece and surface area of the workpiece onto which the energy beam is focused; exerting a force on the workpiece to cause at least a bead of molten material to be ejected away from the pool and solidify to form at least a particle of powder, and
using the sensor means to determine the size and shape of each particle of powder formed by the apparatus.

45. The method of claim 44, the method comprising the step of:
focussing the energy source on the workpiece such that a plurality of channels are formed in the workpiece, each channel extending away from a center axis and terminating at a peripheral edge of the workpiece; and
allowing molten material to flow across the surface of the workpiece and through the channels towards the peripheral edge such that beads of molten material are ejected away from the edge.
